(19) United States
(12) Patent Application Publication
(10) Pub. No.: US 2021/0131422 A1
(43) Pub. Date: May 6, 2021

(54) PUMP NOISE DAMPENER

(71) Applicant: Saudi Arabian Oil Company, Dhahran (SA)

(72) Inventor: Nicholas John PENGILLY, Dhahran (SA)

(21) Appl. No.: 16/673,483

(22) Filed: Nov. 4, 2019

(51) Int. Cl. F04B 53/00; F04B 39/00

(52) U.S. Cl. CPC F04B 53/001; F04B 39/0027

(57) ABSTRACT

A plumbing system including a pump noise dampener is provided. The plumbing system comprises: a pump to output a flow of process liquid; a measurement device to measure a flow rate of the process liquid output from the pump; and a process line coupling the output of the pump to an input of the measurement device. The pump noise dampener is disposed between the pump and the measurement device. The pump noise dampener comprises a bladderless, single chamber pressure vessel to hold the process liquid at a prescribed pressure and an isolation valve tying the pressure vessel into the process line in order to control a flow of the process liquid output from the pump into and out of the pressure vessel and to the measurement device. The pressure vessel is further configured to dampen noise of the process liquid output from the pump and input to the measurement device.

### FIELD OF THE DISCLOSURE

The present disclosure relates to a pump noise dampener and a method of dampening pump noise.

### BACKGROUND OF THE DISCLOSURE

In the field of liquid pump technology, suppression of vibrations, pulses, and other noise can assist downstream users of liquid flow from the pump. An example downstream use of the pipe flow is measuring the flow to regulate a system. However, effects from vibrations, pulses, and other noise from the pump flow can introduce downstream measurement inaccuracies in the system significant enough to impair regulation of the system.

It is in regard to these and other problems in the art that the present disclosure is directed to provide a technical solution for an effective pump noise dampener and a method of dampening pump noise.

### SUMMARY OF THE DISCLOSURE

According to an embodiment, a pump noise dampener includes: a bladderless, single chamber pressure vessel suitable for holding a process liquid at a prescribed pressure; and an isolation valve to tie the pressure vessel into a process line which couples an upstream pump to a downstream plumbing device in order to control a flow of the process liquid output from the pump into and out of the pressure vessel and to the plumbing device. The pressure vessel is further configured to dampen noise of the process liquid output from the pump and into the plumbing device.

In an embodiment, the pump noise dampener further includes a re-pressurization valve to control a flow of re-pressurization fluid into the pressure vessel in order to bring the process liquid in the pressure vessel to a prescribed pressure.

In an embodiment, the isolation valve is further configured to operate below the pressure vessel and the re-pressurization valve is further configured to operate above the pressure vessel with respect to the direction of gravity.

In an embodiment, the plumbing device is a measurement device to measure a flow rate of the process liquid output from the pump.

In an embodiment, the pressure vessel is further configured to operate at higher than atmospheric pressure, and the prescribed pressure is higher than atmospheric pressure.

In an embodiment, the isolation valve is further configured to operate below the pressure vessel with respect to the direction of gravity.

In an embodiment, the isolation valve is further configured to bring the pump noise dampener online of and take the pump noise dampener offline from the process line by opening and closing, respectively.

According to an embodiment, a method of pump noise dampening includes: holding process liquid at a prescribed pressure using a bladderless, single chamber pressure vessel; controlling, using an isolation valve, a flow of the process liquid output from an upstream pump into and out of the pressure vessel and to a downstream plumbing device by tying the pressure vessel into a process line coupling the pump to the plumbing device; and dampening, using the pressure vessel, noise of the process liquid output from the pump and input to the plumbing device.

In an embodiment, the method further includes bringing the process liquid in the pressure vessel to the prescribed pressure by controlling a flow of re-pressurization fluid into the pressure vessel using a re-pressurization valve.

In an embodiment, the method further includes operating the isolation valve below the pressure vessel and operating the re-pressurization valve above the pressure vessel with respect to the direction of gravity.

In an embodiment, the method further includes measuring a flow rate of the process liquid output from the pump using a measurement device as the plumbing device.

In an embodiment, the method further includes operating the pressure vessel at higher than atmospheric pressure, wherein the prescribed pressure is higher than atmospheric pressure.

In an embodiment, the method further includes operating the isolation valve below the pressure vessel with respect to the direction of gravity.

In an embodiment, the method further includes bringing the pressure vessel online of and taking the pressure vessel offline from the process line by opening and closing the isolation valve, respectively.

According to an embodiment, a plumbing system includes: a pump to output a flow of process liquid; a measurement device to measure a flow rate of the process liquid output from the pump; a process line coupling the output of the pump to an input of the measurement device; and a pump noise dampener between the pump and the measurement device. The pump noise dampener includes: a bladderless, single chamber pressure vessel to hold the process liquid at a prescribed pressure; and an isolation valve tying the pressure vessel into the process line in order to control a flow of the process liquid output from the pump into and out of the pressure vessel and to the measurement device. The pressure vessel is further configured to dampen noise of the process liquid output from the pump and input to the measurement device.

In an embodiment, the pump noise dampener further includes a re-pressurization valve to control a flow of re-pressurization fluid into the pressure vessel in order to bring the process liquid in the pressure vessel to the prescribed pressure.

In an embodiment, the isolation valve is further configured to operate below the pressure vessel and the re-pressurization valve is further configured to operate above the pressure vessel with respect to the direction of gravity.

In an embodiment, the pressure vessel is further configured to operate at higher than atmospheric pressure, and the prescribed pressure is higher than atmospheric pressure.

In an embodiment, the isolation valve is further configured to operate below the pressure vessel with respect to the direction of gravity.

In an embodiment, the isolation valve is further configured to bring the pump noise dampener online of and take the pump noise dampener offline from the process line by opening and closing, respectively.

Any combinations of the various embodiments and implementations disclosed herein can be used. These and other aspects and features can be appreciated from the following description of certain embodiments and the accompanying drawings and claims.

### BRIEF DESCRIPTION OF THE DRAWINGS

FIG. 1 is a schematic diagram of an example use case for a pumping system including a pump noise dampener, according to an embodiment.

FIG. 2 is an illustration of an example pump noise dampener, according to an embodiment.

FIG. 3 is a graph of the output of a downstream measurement device of a pump flow from an upstream system pump, before and after tying in an example pump noise dampener, according to an embodiment.

FIG. 4 is a flow chart of an example method of pump noise dampening, such as for use by the pump noise dampener of FIG. 2, according to an embodiment.

It is noted that the drawings are illustrative and not necessarily to scale.

### DETAILED DESCRIPTION OF CERTAIN EMBODIMENTS OF THE DISCLOSURE

Example embodiments of the present disclosure are directed to a pump noise dampener and a method of dampening pump noise. In one such embodiment, the addition of a vessel to the outlet of a pump absorbs pulses and vibrations from the pump, which enables smooth measurements of liquid flow from the pump. In this technique, erratic liquid flow measurements are smoothed by receiving the pump flow into a pressure vessel (or dampening vessel) prior to any further downstream propagation of the liquid flow. The pressure vessel has a simple design, with a single chamber, no internal bladder, and sturdy walls to withstand prescribed pressures as may be desired for a given operation of the process line. In addition, the pressure vessel has two valve connections: one below for tying into the process flow, and one above for re-pressurization, such as with gas or with process liquid at pressures suitable to pressurize the pressure vessel to a desired level. As used herein, above and below are with respect to the direction of gravity.

As discussed earlier, vibrations, pulses, and other pump flow noise can disrupt downstream users of the pump flow. For example, such noise can result in significant inaccuracies in downstream measurements of the pump flow. These inaccuracies can lead to improper decisions or management taking place that rely on accurate measuring. Existing solutions have complex internal structures and mechanisms, with multiple vessels, bladders within the vessels, no ability to withstand high pressures, and no ability to bring online or take offline without serious disruption to the system. Further, existing solutions are often specific designs for specific pumps, such that each pump manufacturer's solution (if any) only works for that manufacturer's pump.

Accordingly, in an example embodiment, a pump noise dampener is installed downstream of a pump's liquid outlet. The pump noise dampener is not part of the process flow stream, rather it taps into the liquid process flow from the pump using an isolation valve. As such, the pump noise dampener can be brought online or taken offline by adjusting the isolation valve. The pump noise dampener is designed to remove noise (e.g., pulses, vibrations, and the like) in the process stream created by the pump's movement of liquid. The noise commonly appears in the output of many types of pumps, and can create downstream problems, for example, in flow measurement lines. The noise can also diminish the accuracy of flow measurement devices. As such, the pump noise dampener provides for accurate flow measurement. This can be especially useful in pre-production environments, such as laboratory equipment and pilot plant installations, where exact measurement and quantifying of liquid material (mass) is important.

In further detail, the pump noise dampener has an inlet process connection that can be sized for a variety of processes and is capable of handling higher than atmospheric pressures. The pump noise dampener includes a valve for isolation, a pressure vessel, a valve for re-pressurization, and all pipe work or other plumbing for a single process connection point. The pressure vessel is simple, including a single chamber, no internal media, and no bladder, and is capable of being brought on- and offline through the isolation valve. The pressure vessel can also be brought to a prescribed pressure by closing the isolation valve and using the re-pressurization valve to bring the pressure vessel to any given prescribed pressure suitable for the pump, the process line, the downstream plumbing device, or all of these components. In addition, the pump noise dampener's simple design and isolation valve allows the pump noise dampener to work with any upstream pump and any downstream process device of the process line into which the pump noise dampener is tying.

In summary, according to various embodiments, the pump noise dampener is simple to install and with no major plant modification. In addition, the pump noise dampener works with many pump types and pump manufacturers. Further, the pump noise dampener can be used in many systems with different flow meter instruments and flow meter manufacturers. The pump noise dampener also has no internal membrane or complex structure (e.g., multiple chambers), and is more reliable than alternative designs that do use internal membranes or complex structures. Moreover, the pump noise dampener can operate at higher pressures and can be re-pressured to suit a wide variety of operating conditions or pressures compared to alternative designs.

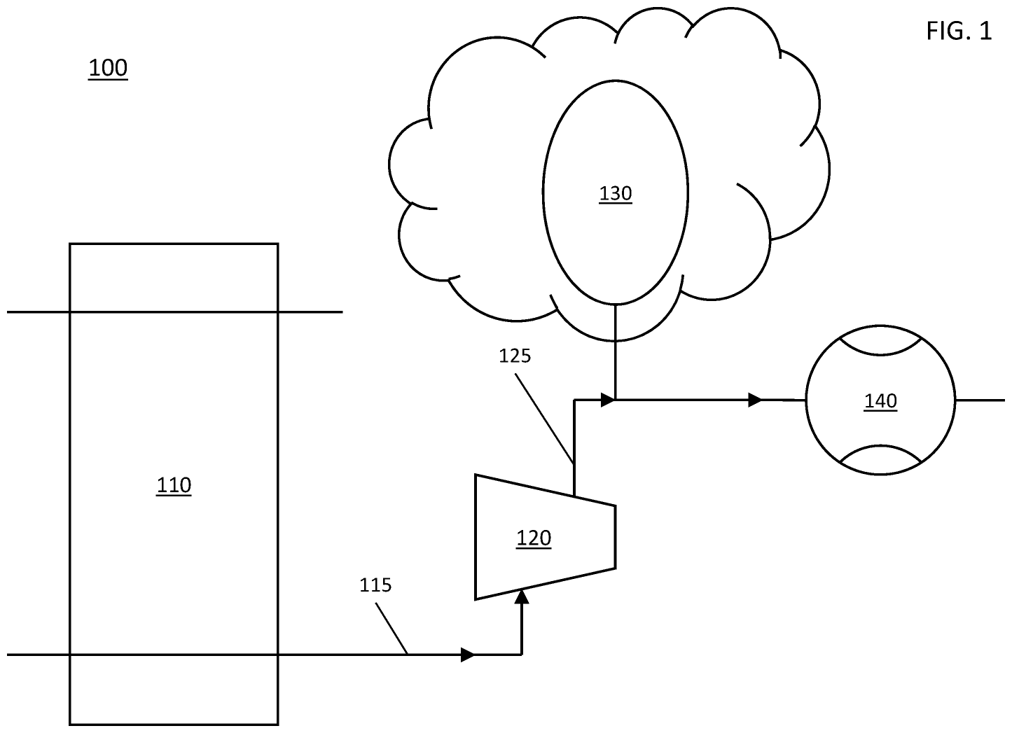

FIG. 1 is a schematic diagram of an example use case 100 for a pumping system including a pump noise dampener, according to an embodiment. In the use case 100, there is a feed tank 110 receiving inputs and supplying liquid outputs, including process output 115. The process output 115 is directed to a pump 120, which can be any type of pump, such as a positive displacement pump, an impulse pump, or a velocity pump. The output 125 of the pump 120 is directed to a liquid flow instrument 140, which can be any type of flow instrument, such as a solid state flow sensor, a flow meter (like an ultrasonic liquid flow meter, a volumetric flow meter, or a digital mass flow meter, to name a few), or other flow instrument. Before reaching the liquid flow instrument 140, the pump output 125 encounters the pump noise dampener, which includes a dampening vessel 130 (such as a pressure vessel), that taps into the pump output line. The dampening vessel 130 smooths the pump output 125, which otherwise would include pulses, vibrations, and other noise from the pump 120.

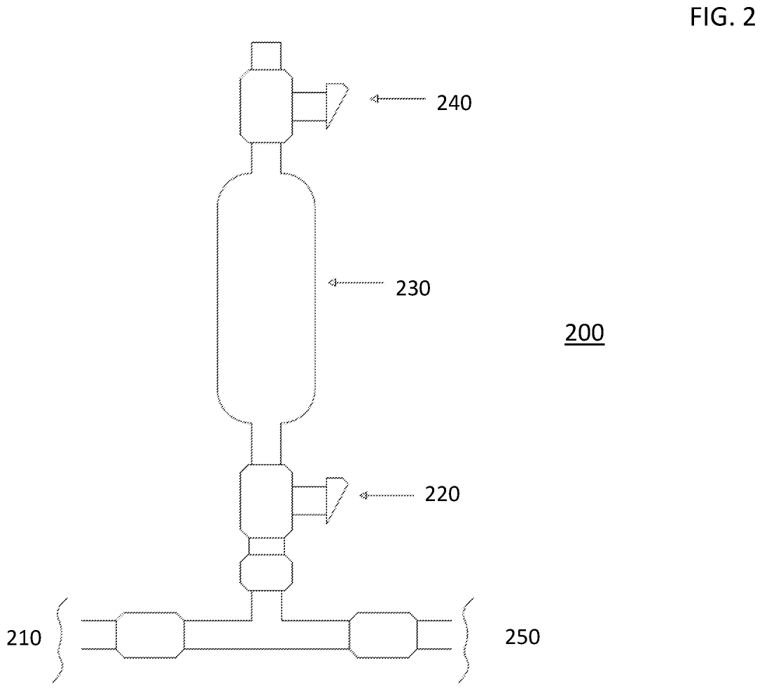

FIG. 2 is an illustration of an example pump noise dampener 200, according to an embodiment. The pump noise dampener 200 includes a process isolation valve 220 to tie the pump noise dampener 200 in with an existing pumping system. An upstream liquid pump supplies a pump outlet process connection 210 on one side of the process isolation valve 200. In addition, a downstream liquid flow instrument (such as a flow meter) receives a downstream process connection 250 on the other side of the process isolation valve 220.

The pump noise dampener 200 further includes a pressure vessel 230 to receive a possibly noisy flow from the pump outlet process connection 210. A “noisy” flow is one which is characterized by an undesirable level of turbulence in the fluid flow into the process line from the pump such as due to vibrations, pulses, and other factors which disrupt smooth flow from the pump, as discussed above. The pressure vessel 230 smooths out the noise from the flow, e.g., letting all or most of the flow enter the pressure vessel and settle before mixing again at the process isolation valve 220 to become part of the downstream process connection 250. As such, the settling of the flow reduces the noise or turbulence and provides a more regular flow for the downstream process connection 250. The pump noise dampener 200 further includes a re-pressurization valve 240 to set or maintain the pressure vessel 230 at a prescribed pressure, such as a stable pressure having a level that causes noisy input from the pump outlet process connection 210 to enter the pressure vessel 230 while providing a smooth output to the downstream process connection 250 to leave the pressure vessel 230.

The pump noise dampener 200 removes noise from (and as observed in) downstream flow measurement instrumentation. The pump noise dampener 200 absorbs pulses and other noise from the pump, creating smoother flow in the process lines. The pump noise dampener 200 ensures accurate measurements of liquid flow (mass), which can lead to better control of liquid flow in the plant or system. Stable liquid flow aids in the stable operation of the plant, which directly improves the accuracy of the data produced by the plant, specifically the plant's mass balance. This is particularly important for laboratory settings and pilot plants, where such data leads to better decisions for production facilities based on the laboratories and pilot plants.

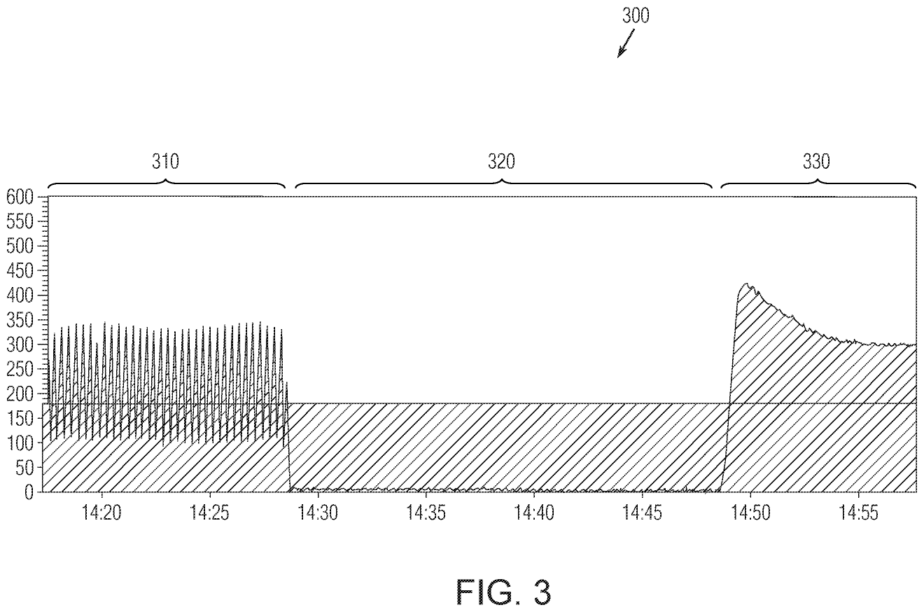

FIG. 3 is a graph 300 of the output of a downstream measurement device of a pump flow from an upstream system pump, before and after tying in an example pump noise dampener (such as the pump noise dampener 200), according to an embodiment. To demonstrate the effectiveness of the pump noise dampener, an experimental model was deployed in a pilot plant setting that included the upstream system pump, the pump noise dampener, and the downstream measurement device. The results of the experiment are illustrated in the graph 300, which displays a timeline of the pump flow speed as measured by the downstream measurement device. In the graph 300, the horizontal (or X) axis represents time (in hours and minutes, from 14:18 through 14:57) while the vertical (or Y) axis represents downstream measured process flow, in normal liters per hour (Nl/hr).

For the measurement illustrated in FIG. 3, the system pump was placed in manual mode, with a 50% duty speed. In the beginning of the graph 300 (left side, pre-dampening portion 310) the system flow is erratic, fluctuating between 100 and 350 Nl/hr even though there is a constant pump speed. This is an illustration of “noise” that is to be dampened or smoothed by the pump noise dampener of the present disclosure. This is displayed by the erratic flow portion 310 in the graph 300 between 14:18 and 14:28. At time 14:29, the pump noise dampener isolation valve was opened to bring the pump noise dampener online. This brought about a no-flow portion 320 during which the pressure vessel on the pump noise dampener was priming, diverting most if not all of the process flow. This priming portion 320 lasted about 20 minutes while the pressure in the pressure vessel equalized with the pressure in the process line, which resulted in zero flow being measured at the downstream measurement device. Once the pressure equalized (right side of the graph 300, post dampening portion 330), the liquid flow as measured through the flow meter smoothed out, eventually settling at a stable flow of 300 Nl/hr with little to no noise in the line recorded.

In an embodiment, the pump noise dampener is part of a pump system where the system is placed in automatic mode, with the pump being controlled using a proportional integral derivative (PID) loop controller. In an experiment, this combination demonstrated even smoother control of the pump output, with fewer erratic changes in speed, compared to the pump being in manual mode (at 50% duty speed).

According to various embodiments, the pump noise dampener can be easily added to any system with a simple tie in. This is in contrast to other products that are more complex and require modifications to the system (besides the simple tie in). The pump noise dampener also works with many pump types and pump manufacturers. This contrasts with dampeners provided by some pump manufacturers, which are specific to their pumps and their models. This forces the end user to buy additional products and spare parts for each type of pump they have installed. In addition, the pump noise damp dampener can be used in many systems with different flow meter instruments and flow meter manufacturers. This is as opposed to other dampeners that have to work with specific instruments or manufacturers. Further, the pump noise dampener has no internal membrane or complex structure (such as multiple chambers), which helps the pump noise dampener be more reliable than alternative solutions. The pump noise dampener can also operate at higher pressures and can be re-pressured to suit a wide variety of operating conditions or pressures compared to other designs.

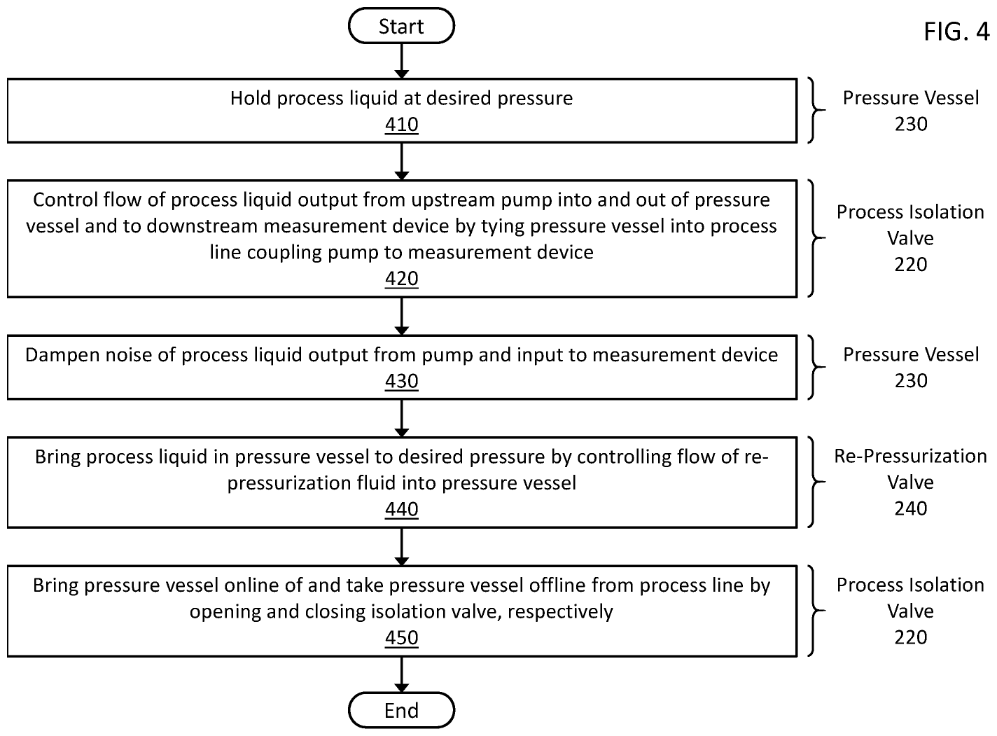

FIG. 4 is a flow chart of an example method 400 of pump noise dampening, such as for use by the pump noise dampener 200 of FIG. 2, according to an embodiment. Some or all of the method 400 can be performed using components and techniques illustrated in FIGS. 1-3. Portions of this and other methods disclosed herein can be performed on or using a custom or preprogrammed logic device, circuit, or processor, such as a programmable logic circuit (PLC), computer, software, or other circuit (e.g., ASIC, FPGA) configured by code or logic to carry out their assigned task. The device, circuit, or processor can be, for example, a dedicated or shared hardware device (such as a laptop, a workstation, a tablet, a smartphone, part of a server, or a dedicated hardware circuit, as in an FPGA or ASIC, or the like), or computer server, or a portion of a server or computer system. The device, circuit, or processor can include a non-transitory computer readable medium (CRM, such as read-only memory (ROM), flash drive, or disk drive) storing instructions that, when executed on one or more processors, cause portions of the method 400 (or other disclosed method) to be carried out. It should be noted that in other embodiments, the order of the operations can be varied, and that some of the operations can be omitted.

In the example method 400, processing begins with the step of holding 410 a process liquid at a prescribed pressure (such as higher than atmospheric pressure) using a bladderless, single chamber pressure vessel (such as pressure vessel 230). The method 400 further includes the step of controlling 420, using an isolation valve (such as process isolation valve 220), a flow of the process liquid output from an upstream pump (such as pump 120) into and out of the pressure vessel and to a downstream plumbing device (such as a measurement device, like liquid flow instrument 140) by tying the pressure vessel into a process line (such as pump output 125) coupling the pump to the measurement device. The method 400 also includes the step of dampening 430, using the pressure vessel, noise of the process liquid output from the pump and input to the plumbing device.

In addition, the method 400 includes the step fo bringing 440 the process liquid in the pressure vessel to the prescribed pressure by controlling a flow of re-pressurization fluid into the pressure vessel using a re-pressurization valve (such as re-pressurization valve 240). Further, the method 400 includes the step of bringing 450 the pressure vessel online of and taking the pressure vessel offline from the process line by opening and closing the isolation valve, respectively.

The methods described herein may be governed in part or in full by software or firmware in machine readable form on a tangible (e.g., non-transitory) storage medium. For example, the software or firmware may be in the form of a computer program including computer program code adapted to perform some or all of the steps of any of the methods described herein when the program is run on a computer or suitable hardware device (e.g., FPGA), and where the computer program may be embodied on a computer readable medium. Examples of tangible storage media include computer storage devices having computer-readable media such as disks, thumb drives, flash memory, and the like, and do not include propagated signals. Propagated signals may be present in a tangible storage media, but propagated signals by themselves are not examples of tangible storage media. The software can be suitable for execution on a parallel processor or a serial processor such that the method steps may be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the scope of the present disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing, and are not to be construed as limiting. However, it is recognized these terms could be used with reference to a viewer. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A pump noise dampener disposed within a process line which couples an upstream pump to a downstream plumbing device, comprising:
a bladderless, single chamber pressure vessel suitable for holding a process liquid at a prescribed pressure; and
an isolation valve positioned to tie the pressure vessel into the process line in order to control a flow of the process liquid output from the upstream pump into and out of the pressure vessel and to the downstream plumbing device,
wherein the pressure vessel is further configured to dampen noise of the process liquid output from the pump and into the plumbing device.

2. The pump noise dampener of claim 1, further comprising a re-pressurization valve to control a flow of re-pressurization fluid into the pressure vessel in order to bring the process liquid in the pressure vessel to a prescribed pressure.

3. The pump noise dampener of claim 2, wherein the isolation valve is further configured to operate below the pressure vessel and wherein the re-pressurization valve is further configured to operate above the pressure vessel with respect to the direction of gravity.

4. The pump noise dampener of claim 1, wherein the plumbing device is a measurement device to measure a flow rate of the process liquid output from the pump.

5. The pump noise dampener of claim 1, wherein the pressure vessel is further configured to operate at higher than atmospheric pressure, and the prescribed pressure is higher than atmospheric pressure.

6. The pump noise dampener of claim 1, wherein the isolation valve is further configured to operate below the pressure vessel with respect to the direction of gravity.

7. The pump noise dampener of claim 1, wherein the isolation valve is further configured to bring the pump noise dampener online of and take the pump noise dampener offline from the process line by opening and closing, respectively.

8. A method of pump noise dampening, the method comprising:
holding a process liquid at a prescribed pressure using a bladderless, single chamber pressure vessel;
controlling, using an isolation valve, a flow of the process liquid output from an upstream pump into and out of the pressure vessel and to a downstream plumbing device by tying the pressure vessel into a process line which couples the pump to the plumbing device; and
dampening, using the pressure vessel, noise in the process liquid output from the pump for input to the plumbing device.

9. The method of claim 8, further comprising bringing the process liquid in the pressure vessel to the prescribed pressure by controlling a flow of re-pressurization fluid into the pressure vessel using a re-pressurization valve.

10. The method of claim 9, further comprising operating the isolation valve below the pressure vessel and operating the re-pressurization valve above the pressure vessel with respect to the direction of gravity.

11. The method of claim 8, further comprising measuring a flow rate of the process liquid output from the pump using a measurement device as the plumbing device.

12. The method of claim 8, further comprising operating the pressure vessel at higher than atmospheric pressure, wherein the prescribed pressure is higher than atmospheric pressure.

13. The method of claim 8, further comprising operating the isolation valve below the pressure vessel with respect to the direction of gravity.

14. The method of claim 8, further comprising bringing the pressure vessel online of and taking the pressure vessel offline from the process line by opening and closing the isolation valve, respectively.

15. A plumbing system comprising:
a pump connected to output a flow of a process liquid;
a measurement device positioned to measure a flow rate of the process liquid output from the pump;
a process line coupling the output of the pump to an input of the measurement device; and
a pump noise dampener between the pump and the measurement device and comprising:
a bladderless, single chamber pressure vessel suitable for holding the process liquid at a prescribed pressure;
an isolation valve connected to tie the pressure vessel into the process line in order to control a flow of the process liquid output from the pump into and out of the pressure vessel and toward the measurement device; and
wherein the pressure vessel is further configured to dampen noise of the process liquid output from the pump and into the measurement device.

16. The plumbing system of claim 15, wherein the pump noise dampener further comprises a re-pressurization valve to control a flow of re-pressurization fluid into the pressure vessel in order to bring the process liquid in the pressure vessel to the prescribed pressure.

17. The plumbing system of claim 16, wherein the isolation valve is further configured to operate below the pressure vessel and the re-pressurization valve is further configured to operate above the pressure vessel with respect to the direction of gravity.

18. The plumbing system of claim 15, wherein the pressure vessel is further configured to operate at higher than atmospheric pressure, and the prescribed pressure is higher than atmospheric pressure.

19. The plumbing system of claim 15, wherein the isolation valve is further configured to operate below the pressure vessel with respect to the direction of gravity.

20. The plumbing system of claim 15, wherein the isolation valve is further configured to bring the pump noise dampener online of and take the pump noise dampener offline from the process line by opening and closing, respectively.
